(19) United States
(12) Patent Application Publication
(10) Pub. No.: US 2002/0067368 A1
(43) Pub. Date: Jun. 6, 2002

(54) System and method for providing acoustic management in a computer

(76) Inventors: Thomas R. Colligan, Austin, TX (US); Gregory A. Weir, Austin, TX (US)

Correspondence Address: David L. McCombs, Haynes and Boone, L.L.P., Suite 3100, 901 Main Street, Dallas, TX, 75202-3789, US

(21) Appl. No.: 09/727,667

(22) Filed: Dec. 1, 2000

(51) Int. Cl. G06F 3/00

(52) U.S. Cl. 345/716; 345/727

(57) ABSTRACT

A graphical user interface (“GUI”) for enabling a user to select an acoustic level at which a computer should operate, for example, as a percentage of the full acoustic level. Once a level is selected, the performance of various computer subsystems is adjusted to achieve the selected acoustic level and the user may preview the selected level by selecting a button on the GUI. In one embodiment, this adjustment is performed using predefined operational states of the computer.

### BACKGROUND

The disclosures herein relate generally to computers and more particularly to a system and method for providing acoustic management in a computer.

With the increase in speed (“RPM”) of computer hard disk drives, the noise attributable to the drives may tend to annoy purchasers of computers, causing them to them either to contact customer support in search of methods by which to reduce the noise level or, in extreme cases, return the hard drive or the entire computer. Currently, a standard exists for providing 126 different acoustic levels of hard drive operation. A lowering in the acoustic level is accomplished by decreasing the seek performance (or RPM) of the drive, thereby to reduce the seek noise. Currently, the acoustic level of each hard drive in a computer is set by the manufacturer of the hard disk drive at a level specified by an OEM customer. At present, there are no means for enabling the end-user to adjust this level.

Additional noise is generated by the fans in the computer, including, for example, the system fan and the processor fan. In particular, as computers become capable of operating at higher speeds, it is necessary to include more and/or higher power fans to keep the computer sufficiently cool to operate properly. As a result, considerable noise is generated by these fans. This can also cause annoyance to the customer, who may react as described above. The noise created by the fans can be reduced by decreasing the speed of one or more of the fans; however, if the reduction in fan speed is not accompanied by a commensurate reduction in peripheral and/or processor activity level, the thermal level of the computer can rise to such a degree as to pose a danger to components thereof.

Therefore, what is needed is a system and method for providing an interface to enable a user to select an acoustic level for a computer and for causing an appropriate adjustment in overall system operation to accommodate the selected acoustic level.

### SUMMARY

One embodiment, accordingly discloses a method of providing acoustic management in a computer including receiving from a user, instructions regarding a selected acoustic level via an interface. An operational level of at least one subsystem of the computer is adjusted to achieve the selected acoustic level.

A principal advantage of this embodiment is that it enables a user easily to select a desired acoustic level of a computer, while automatically adjusting system performance to accommodate the selected level.

### BRIEF DESCRIPTION OF THE DRAWING FIGURES

FIG. 1 is a system block diagram of a computer for implementing one embodiment.

FIG. 2 illustrates a GUI of the embodiment of FIG. 1.

FIG. 3 is a flowchart of the operation of the embodiment of FIG. 1.

FIG. 4 is a state diagram of the embodiment of FIG. 1.

### DETAILED DESCRIPTION

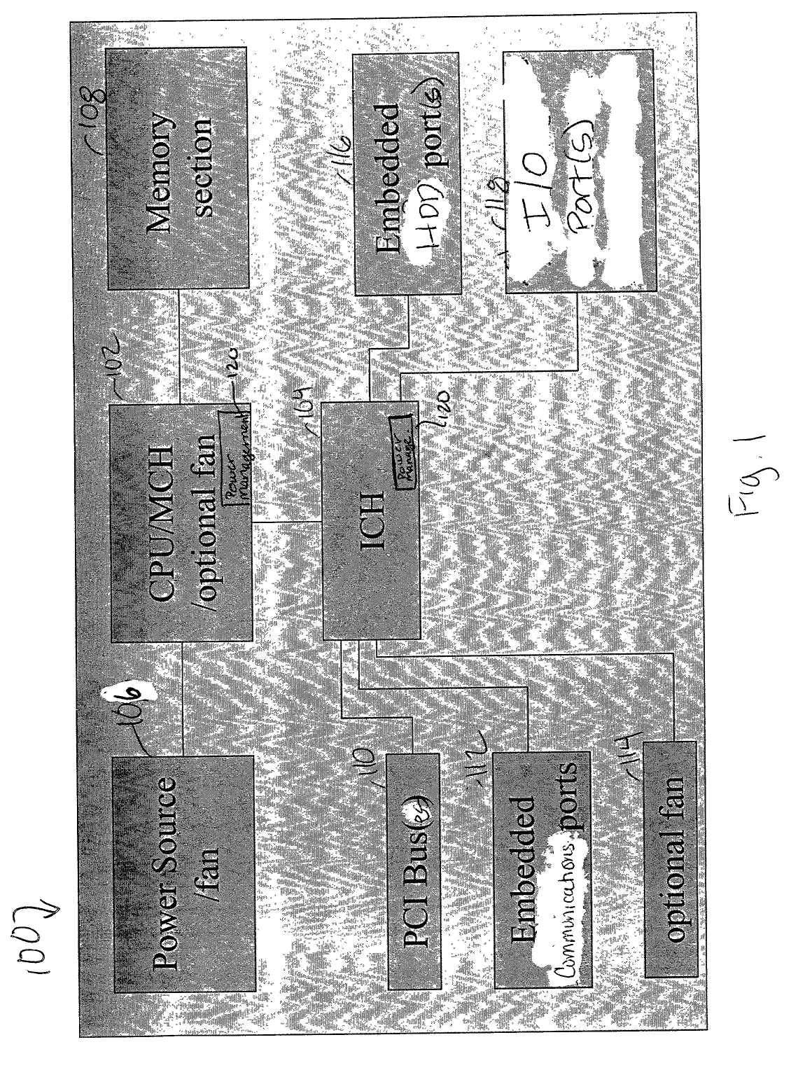

FIG. 1 is a system block diagram of a computer 100 for implementing one embodiment. As shown in FIG. 1, the computer 100 includes a CPU subsystem 102 including a central processing unit, memory controller hardware (“MCH”), and an optional CPU fan, connected to interface controller hardware (“ICH”) 104. A power subsystem 106, including a conventional power source and fan, and system memory 108 are also connected to the CPU subsystem 102. The primary function of the ICH 104 is to control the operation and interaction with the CPU subsystem 102 of various components, including PCI and other types of buses 110, embedded communications ports, including, but not limited to NIC and USB ports, collectively designated by a reference numeral 112, an optional system fan 114, an embedded hard disk drive port 116, such as IDE, serial ATA, SCSI, or FCAL, and various I/O ports, collectively designated by a reference numeral 118. Power management systems 120 are located in both the ICH 104 and the MCH within the CPU subsystem 102, such that each provides power management functions for the hardware to which it is connected in a conventional fashion.

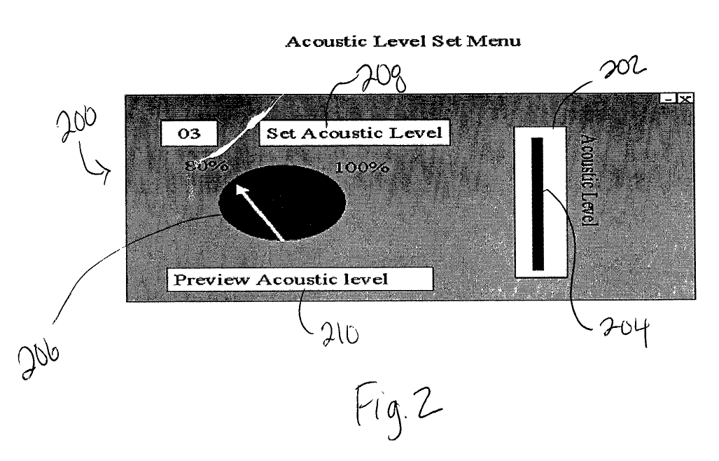

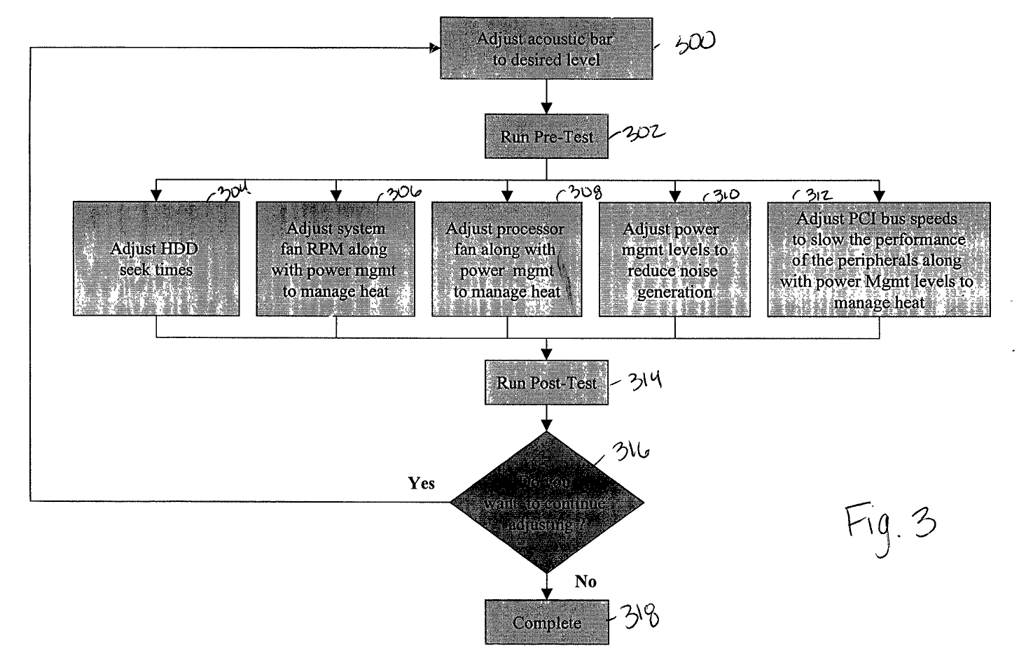

FIG. 2 illustrates a GUI 200 for use in connection with the embodiment described herein. As shown in FIG. 2, the GUI 200 includes an acoustic level bar 202 for enabling a user to select a desired acoustic level by adjusting the level of an indicator 204 using an input device of the computer 100, such as a mouse (not shown). A dial 206 indicates, as a percentage of the maximum possible acoustic level, the acoustic level selected using the bar 202 and indicator 204. Referring now also to FIG. 3, which is a flowchart of the operation of the embodiment described herein, once the indicator 204 has been set to the desired level (step 300), responsive to selection of a “Set Acoustic Level” button 208, a pre-test is run (step 302). During the pre-test, the current hard disk drive seek settings and current system settings are determined. The hard disk drive has a number of preset seek profiles (1 to X), each of which has a known acoustic level. System settings will determine the level of power management, CPU/bus and fan speed; again, each setting has an acoustic level associated therewith.

Next, the acoustic level of the computer 100 is adjusted by performing one or more of steps 304-312 in order until the selected acoustic level is achieved. Specifically, in step 304, the hard disk drive seek times are adjusted downward until the selected acoustic level is achieved or the maximum seek time is reached. Upon completion of step 304, if additional downward adjustment to the acoustic level is necessary, in step 306, the RPM of the system fan 114 is decreased. In addition, the power management system 120 makes appropriate and corresponding adjustments to overall operation of the computer system to decrease the heat production of the computer to a level that can be managed by the system fan operating at its new level. Upon completion of step 306, if additional downward adjustment to the acoustic level is necessary, in step 308, the RPM of the processor fan 102 is decreased. In addition, the power management system 120 makes appropriate and corresponding adjustments to overall operation of the computer system to decrease the heat production of the computer to a level that can be managed by the processor fan operating at its new level.

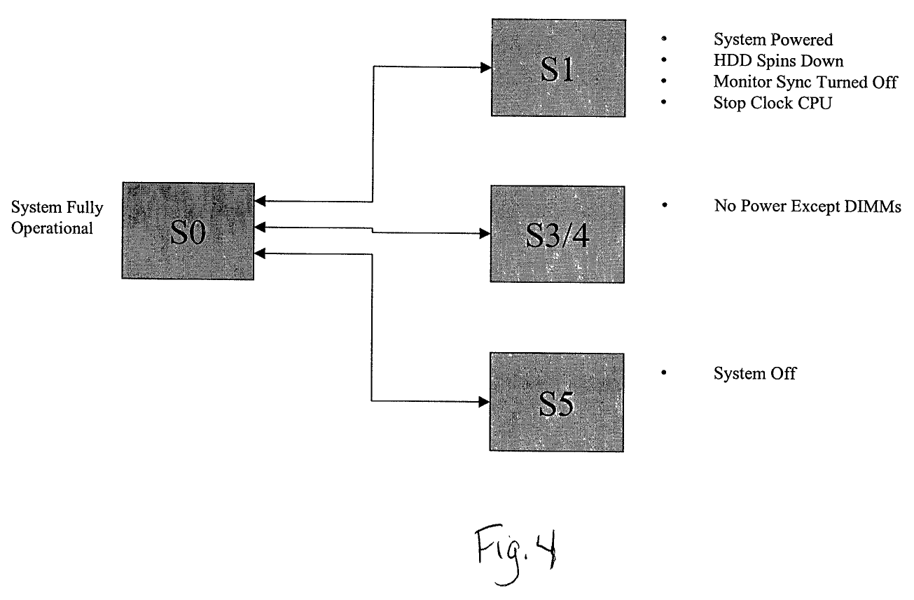

Upon completion of step 308, if additional downward adjustment to the acoustic level is necessary, in step 320, the power management levels (FIG. 4) are adjusted to reduce noise creation. Upon completion of step 310, if additional downward adjustment to the acoustic level is necessary, in step 312, the speed of the PCI bus 110 is decreased. In addition, the power management system 120 makes appropriate and corresponding adjustments to overall operation of the computer system so that the level of computer system activity can be accommodated by the PCI bus operating at the decreased speed. It should be noted that steps 304-312 may be performed in any order, as warranted by the particular situation or as desired.

Once one or more of steps 304-312 have been performed, execution proceeds to step 314, in which a post-test is run. The post-test is similar to the pretest, but is used to demonstrate to the user what the new acoustic level sounds like. At that point, the user indicates whether or not he or she would like to continue adjusting the acoustic level. In step 316, a determination is made whether the user wants to readjust the acoustic level of the computer 100. If so, execution returns to step 300; otherwise, execution terminates in step 318.

It will be recognized that computer program instructions executable by a processor, such as the CPU, for causing the computer 100 to display the GUI of FIG. 2 and to execute the steps described in FIG. 3 are stored on appropriate storage media or devices within or inserted into the computer 100.

Referring again to FIG. 2, selection of a “Preview Acoustic Level” button 210 results in the acoustic level selected by the user being demonstrated to the user to enable him or her to decide whether to readjust the acoustic level (step 316).

FIG. 4 illustrates a state diagram 400 of the operational states of the computer 100. These states are the power management states the computer 100 supports and are a subset of the flowchart and the GUI. As shown in FIG. 4, in a first state S0, the computer 100 is fully operational, power savings occurs on a per-device basis, and devices that are not in use can save power by entering a lower power state. In a second or “sleep” state S1, the hard disk drive and monitor are disabled. In a third or “Suspend-to-RAM (‘STR’)” state of a fourth or “Suspend-to-Disk (‘STD’)” state, collectively designated S3/S4, the computer 100 is suspended to RAM and powered off with the operating system (“OS”) context saved in system memory or the computer 100 is suspended to disk. In this state S3/S4, there is no power except to DIMMs. In a fifth or “Soft Off” state S5, the computer 100 is powered off and requires a full boot to load the OS. Depending on the acoustic level selected by the end-user, certain operational states may be adjusted through the predetermined power management states illustrated in the state diagram 400.

Although illustrative embodiments have been shown and described, a wide range of modification change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method of providing acoustic management in a computer comprising:
receiving from a user instructions regarding a selected acoustic level via an interface; and
adjusting an operational level of at least one subsystem of the computer to achieve the selected acoustic level.

2. The method of claim 1 further comprising:
subsequent to the adjusting, demonstrating to the user the selected acoustic level.

3. The method of claim 1 wherein the adjusting an operational level of at least one subsystem of the computer comprises adjusting a seek time of a hard disk drive of the computer.

4. The method of claim 1 wherein the adjusting an operational level of at least one subsystem of the computer comprises adjusting the speed of an internal fan.

5. The method of claim 4 wherein the adjusting an operational level of at least one subsystem of the computer comprises making corresponding adjustments to overall operation of a portion of the computer to maintain a heat production level of the computer at a level that can be managed by the internal fan operating at the adjusted speed.

6. The method of claim 1 wherein the adjusting an operational level of at least one subsystem of the computer is performed using redefined power management levels of the computer.

7. The method of claim 1 wherein the adjusting an operational level of at least one subsystem of the computer comprises adjusting a speed of a peripheral bus, with corresponding adjustments to a speed of at least one peripheral device connected to the peripheral bus.

8. The method of claim 1 further comprising, prior to the receiving, displaying a graphical user interface for enabling the user to select an acoustic level.

9. A system for providing acoustic management in a computer comprising:
means for receiving from a user instructions regarding a selected acoustic level; and
means for adjusting an operational level of at least one subsystem of the computer to achieve the selected acoustic level.

10. The system of claim 9 further comprising:
means for previewing to the user the selected acoustic level subsequent to the adjusting.

11. The system of claim 9 wherein the means for adjusting an operational level of at least one subsystem of the computer comprises means for adjusting a seek time of a hard disk drive of the computer.

12. The system of claim 9 wherein the means for adjusting an operational level of at least one subsystem of the computer comprises means for adjusting the speed of an internal fan.

13. The system of claim 12 wherein the means for adjusting an operational level of at least one subsystem of the computer comprises means for making corresponding adjustments to overall operation of a portion of the computer to maintain a heat production level of the computer at a level that can be managed by the internal fan operating at the adjusted speed.

14. The system of claim 9 wherein the means for adjusting an operational level of at least one subsystem of the computer comprises a power management system of the computer.

15. The system of claim 9 wherein the means for adjusting an operational level of at least one subsystem of the computer comprises means for adjusting a speed of a peripheral bus, with corresponding adjustments to a speed of at least one peripheral device connected to the peripheral bus.

16. The system of claim 9 wherein the means for receiving comprises a graphical user interface for enabling the user to select an acoustic level.

17. A computer including an acoustic management system, the computer comprising:
a processor for executing instructions;
at least one subsystem having more than one operational levels;
means for receiving from a user instructions regarding a selected acoustic level; and
means for adjusting an operational level of the at least one of the subsystem to achieve the selected acoustic level.

18. The computer of claim 17 further comprising:
means for previewing to the user the selected acoustic level subsequent to the adjusting.

19. The computer of claim 17 wherein the means for adjusting an operational level of the at least one subsystem of the computer comprises means for adjusting a seek time of a hard disk drive of the computer.

20. The computer of claim 17 wherein the means for adjusting an operational level of the at least one subsystem of the computer comprises means for adjusting the speed of an internal fan.

21. The computer of claim 20 wherein the means for adjusting an operational level of the at least one subsystem of the computer comprises means for making corresponding adjustments to overall operation of a portion of the computer to maintain a heat production level of the computer at a level that can be managed by the internal fan operating at the adjusted speed.

22. The computer of claim 17 wherein the means for adjusting an operational level of the at least one subsystem of the computer comprises a power management system of the computer.

23. The computer of claim 17 wherein the means for adjusting an operational level of the at least one subsystem of the computer comprises means for adjusting a speed of a peripheral bus, with corresponding adjustments to a speed of the at least one peripheral device connected to the peripheral bus.

24. The computer of claim 17 wherein the means for receiving comprises a graphical user interface for enabling the user to select an acoustic level.

25. A computer program product, comprising:
a computer program processable by a computer system for causing the computer system to:
receive from a user instructions regarding a selected acoustic level via an interface;
adjust an operational level of at least one subsystem of the computer to achieve the selected acoustic level; and
apparatus from which the computer program is accessible by the computer system.

26. The computer program product of claim 25 wherein the computer program is processable by a computer system for causing the computer system to demonstrate to the user the selected acoustic level subsequent to the adjusting.

27. The computer program product of claim 25 wherein the computer program is processable by a computer system for causing the computer system to display a graphical user interface for enabling the user to select an acoustic level.

28. The computer program product of claim 25 wherein the adjusting an operational level of at least one subsystem of the computer comprises an action selected from a group consisting of adjusting a seek time of a hard disk drive of the computer, adjusting the speed of an internal fan, using redefined power management levels of the computer, and adjusting a speed of a peripheral bus, with corresponding adjustments to a speed of at least one peripheral device connected to the peripheral bus.

29. The method of claim 28 wherein the adjusting the speed of the internal fan further comprises making corresponding adjustments to overall operation of a portion of the computer to maintain a heat production level of the computer at a level that can be managed by the internal fan operating at the adjusted speed.
